(19) United States
(12) Patent Application Publication
(10) Pub. No.: US 2005/0125220 A1
(43) Pub. Date: Jun. 9, 2005

(54) Method for constructing lexical tree for speech recognition

(75) Inventor: Jun-Seok Kim, Gyeonggi-Do (KR)

Correspondence Address: JONATHAN Y. KANG, ESQ;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/993,724

(22) Filed: Nov. 19, 2004

(30) Foreign Application Priority Data
Dec. 5, 2003 (KR) 88222/2003

(51) Int. Cl. G06F 17/21; G10L 15/06; G10L 19/10

(52) U.S. Cl. 704/10; 704/220

(57) ABSTRACT

Disclosed is a method for constructing a lexical tree for speech recognition, wherein, even though a name included in an address book in a communication device such as a cellular phone and a word such as “house/office/cellular phone” are sequentially and successively uttered, the method allows the uttered speech to be precisely recognized. The method for constructing a lexical tree constructs a lexical tree including a name tree composed of names included in an address book in a communication device and an expansion vocabulary tree composed of words following the names, respectively.

### BACKGROUND OF THE INVENTION

1. Field of the Invention

The present invention relates to a speech recognition method, and more particularly, to a method for constructing a lexical tree for speech recognition.

2. Description of the Background Art

In general, when recording a telephone number in an address book in a cellular phone, several telephone numbers with respect to one person's name can be recorded in the address book. For example, as telephone numbers for a person named “Adrian”, several telephone numbers such as a “house phone number”, an “office phone number”, a “cellular phone number” and the like can be recorded in the address book.

Accordingly, several persons' telephone numbers recorded in the address book in the cellular phone can be searched for by using a speech recognizer of the cellular phone. At this time, when a word to be recognized is expanded, the expansion word should be uttered, leaving a predetermined time difference. For example, when searching for an office phone number of a person named “Adrian”, “Adrian” first should be uttered first, it should be checked whether the speech is recognized, and then an “office” should be uttered. Namely, after searching for a person to be targeted through the speech recognizer, the rest of the word should be uttered so as to recognize whether the telephone number to be finally searched for is the “house phone number” or the “office phone number” or the “cellular phone number”.

In the speech recognizer of the cellular phone in accordance with the conventional art, when a word to be recognized is expanded, there is inconvenience that the expansion word should be uttered leaving the predetermined time difference. In addition, since the speech recognition is performed twice in order to search for one telephone number, there is a problem that the probability of recognition errors occurring is increased. That is, the probability of recognition errors occurring is increased, thereby deteriorating the speech recognition performance of the speech recognizer.

Meanwhile, a technique for a speech recognition apparatus in accordance with the conventional art is disclosed in U.S. Pat. No. 6,061,652.

### SUMMARY OF THE INVENTION

Therefore, an object of the present invention is to provide a method for constructing a lexical tree for speech recognition, wherein, even though a name included in an address book in a communication device such as a cellular phone and a word such as “house/office/cellular phone” are sequentially and successively uttered, the method allows the uttered speech to be precisely recognized.

To achieve these and other advantages and in accordance with the purpose of the present invention, as embodied and broadly described herein, there is provided a method for constructing a lexical tree, comprising: constructing a lexical tree including a name tree composed of names recorded in an address book in a communication device and an expansion vocabulary tree composed of words which follow the names, respectively.

To achieve these and other advantages and in accordance with the purpose of the present invention, as embodied and broadly described herein, there is provided a method for constructing a lexical tree, comprising: constructing a lexical tree including: a name tree composed of names recorded in an address book in a cellular phone; an expansion vocabulary tree composed of words following the names; and a link sound connecting tree connected between the name tree and the expansion vocabulary tree in order to recognize a link sound between the name tree and the expansion vocabulary tree.

To achieve these and other advantages and in accordance with the purpose of the present invention, as embodied and broadly described herein, there is provided a method for generating a lexical tree, comprising: generating a name tree composed of names recorded in an address book in a cellular phone; generating an expansion vocabulary tree composed of words following the names, respectively; and generating a link sound connecting tree connected between the name tree and the expansion vocabulary tree in order to recognize a link sound occurring between the name tree and the expansion vocabulary tree.

To achieve these and other advantages and in accordance with the purpose of the present invention, as embodied and broadly described herein, there is provided a method of recognizing speech through a lexical tree applied to a speech recognizer in a communication device, comprising: constructing a lexical tree including a name tree composed of names recorded in an address book in a communication device, an expansion vocabulary tree composed of words following the names, respectively, and a link sound connecting tree connected between the name tree and the expansion vocabulary tree in order to recognize a link sound between the name tree and the expansion vocabulary tree; and recognizing speech though the constructed lexical tree.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a process of constructing a lexical tree which provides a search space for speech recognition in accordance with the present invention;

FIG. 2 is a view showing a lexical tree when a word “Adrias” is inserted into the lexical tree of FIG. 1;

FIG. 3 is a view showing a name tree and an expansion vocabulary tree in accordance with the present invention;

FIG. 4 is a view showing a structure of an expansion vocabulary tree in accordance with the present invention;

FIG. 5 is a view showing a link state between the name tree and the expansion vocabulary tree;

FIG. 6 is a view showing a data structure of a book for storing information on all the terminal nodes activated at an arbitrary point in time (t);

FIG. 7 is a table showing a CMU phoneset which contains 39 phones coming in the last position when an English word is changed into a phoneme sequence;

FIG. 8 is a view showing a structure of a link sound connecting tree in accordance with the present invention;

FIG. 9 is a view showing a link state between the name tree and the link sound connecting tree in accordance with the present invention; and

FIG. 10 is a view showing a link state between the link sound connecting tree and the expansion vocabulary tree in accordance with the present invention.

### DETAILED DESCRIPTION OF THE PREFERRED EMBODIMENTS

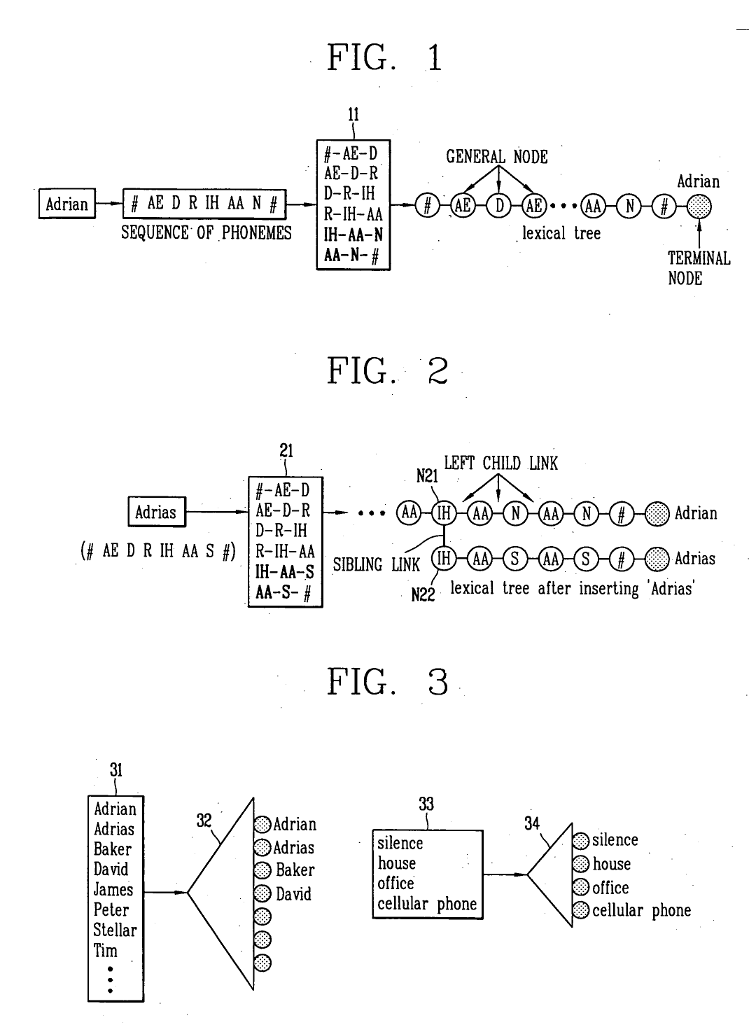

Hereinafter, with reference to FIGS. 1 to 10, description will be made in detail to the preferred embodiment for a method for constructing a lexical tree for speech recognition. By constructing a lexical tree including a name tree composed of names included in an address book in a communication device and an expansion vocabulary tree composed of words following the names, respectively, even though a name included in the address book in the communication device and a word such as “house/office/cellular phone” are sequentially and successively uttered, the method for constructing a lexical for speech recognition allows the uttered speech to be recognized.

Here, in the present invention, by additionally connecting a link sound connecting tree, which allows a link sound between the name tree and the expansion vocabulary tree to be recognized, between the name tree and the expansion vocabulary tree, even though the name included in the address book in the communication device and the word such as “house/office/cellular phone” are successively and sequentially uttered, the uttered speech can be precisely recognized.

FIG. 1 is a view showing a process of constructing a lexical tree which provides a search space for speech recognition in accordance with the present invention. For example, when there is a word, a name “Adrian”, the word is constructed by a phoneme sequence (for example, # AE D R IH AA N #). At this time, a CMS (US English Carnegie Mellon University) phoneset widely used in English-speaking countries is preferably used.

Thereafter, a tri-phone list 11 is generated on the basis of the phoneme sequence. The tri-phone list 11 is a unit for speech recognition, and becomes three nodes when constructing a lexical tree. The nodes are classified into a General Node and a Terminal node which means the last node of each row. Here, one node and another node are connected to each other by a link. The link is classified into a sibling link which connects nodes having the same level and a left child link which connects nodes having different levels in the tree.

FIG. 2 is a view showing a lexical tree when a word “Adrias” is inserted into the lexical tree of FIG. 1.

As shown in FIG. 2, the “Adrias” is converted into a phoneme sequence (for example, # AE D R IH AA N #) and a tri-phone list 21 is generated on the basis of the converted phoneme sequence. At this time, since a part (AE-D, AE-D-R, D-R-IH, R-IH-AA) of the tri-phone list 21 coincides with a part (AE-D, AE-D-R, D-R-IH, R-IH-AA) of the tri-phone list 11, the corresponding nodes belonging to the parts in the lexical tree are preferably shared to save memory. On the other hand, since the tri-phone list 11 and the tri-phone list 21 do not coincide with each other from “IH-AA-N” of the tri-phone list 11 and from “IH-AA-S” of the tri-phone list 21, a first node (N21) of the node “IH-AA-N” which has already been made in the “Adrian” and a first node (N22) of the node “IH-AA-S” which is newly added should be connected by the sibling link.

FIG. 3 is a view showing a name tree and an expansion vocabulary tree in accordance with the present invention.

As shown in FIG. 3, a lexical tree generated from a name list 31 of an address book of a cellular phone is defined as a “name tree 32”. In addition, a lexical tree generated from an expansion vocabulary list 33 including words such as “silence/house/office/cellular phone” which follow the names is defined as an “expansion vocabulary tree”. Here, when a user pronounces a word which belongs only to the name tree, silence is preferably added to the expansion vocabulary list 33 in order to recognize the pronounced word.

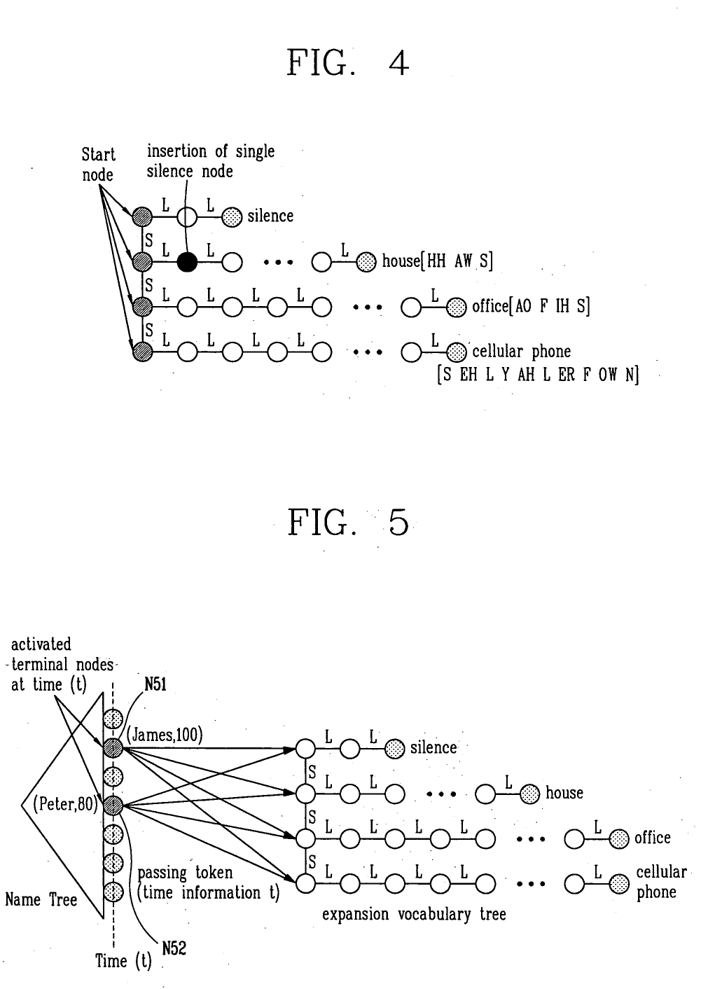

Hereinafter, a structure of the expansion vocabulary tree in accordance with the present invention will be described in detail with reference to FIG. 4.

FIG. 4 is a view showing a structure of an expansion vocabulary tree in accordance with the present invention.

As shown in FIG. 4, a first node of a word such as “silence/house/office/cellular phone” is called a start node. When a search from the first node to a terminal node of the name tree is completed, a token is passed to the first node of the expansion vocabulary tree. The first nodes are connected to each other by sibling links. After the words like “silence/house/office/cellular phone” are converted into phoneme sequences, that is, into house [# HH AW S #], office [# AO F IH S #] and cellular phone [# S EH L Y AH L ER F OW N #], a tri-phone list is written out on the basis of the converted phoneme sequences. At this time, the expansion vocabulary tree is preferably constructed with the same method the name tree uses. Here, “S” stands for a sibling link, and “L” stands for a left child link.

In addition, a single silence node is preferably connected to the first node of the expansion vocabulary tree in order to recognize a word “house”, particularly. That is, people have a tendency to take a little pause when uttering “XXX house”, and, taking the tendency into accounts, the single silence node is preferably connected to the first node of the expansion vocabulary tree. Experiments show that the recognition performance of the speech recognizer is significantly improved when the single silence node is inserted into the expansion vocabulary tree, compared to when it is not.

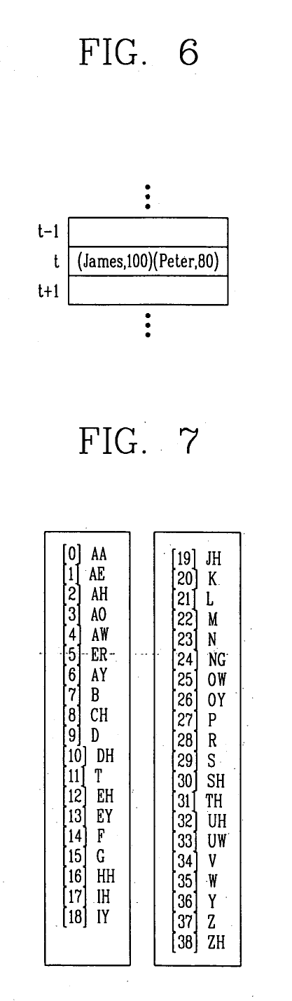

Hereinafter, a process of connecting the name tree and the expansion vocabulary tree to each other and a process of outputting recognition results will be described in detail with reference to FIGS. 5 and 6.

As shown in FIG. 5, when nodes activated in the name tree at an arbitrary point in time (t) are terminal nodes (N51 and N52), tokens are passed to all the start nodes of the expansion vocabulary tree. Here, the token refers to time information (t), through which terminal nodes (names) and scores which have reached in the time can be found in a book. The time information refers to information which indicates a time taken to determine similarities between the users' speech and the lexical tree.

In addition, when moving from one node to another node, scores are given according to how precisely the users' speech is matched with the phoneme sequence till the corresponding node. For example, when users' speech input is similar to the phoneme sequence, a high score is given, but otherwise a low score is given.

FIG. 6 is a view showing a data structure of a book for storing information on all the terminal nodes activated at an arbitrary point in time (t).

As shown in FIG. 6, pairs of name words of each terminal node activated at each point of time and scores till now are stored in the book. Here, a state that (James 100) and (Peter 80) at each arbitrary point of time (t) are stored is taken as an example. (James 100) means that a terminal node corresponding to “James” in the name tree is activated to pass tokens to the expansion vocabulary tree and that a HMM (Hidden Markov Model) score up to that time (t) is 100. Since the HMM is a basic technique widely used for speech recognition, its detailed description will be omitted. Here, a score from the first node to the terminal node (word) of the name tree becomes one pair.

Thereafter, when a search is completed to the terminal node of the expansion vocabulary tree, a word corresponding to a pair which has the highest HMM score among the pairs in the book data structure is selected using the passed token information (time information) and the selected word is outputted as search results. For example, when the search is completed to the terminal node of the expansion vocabulary tree, if the word is “office” and the token information is “t”, a word corresponding to a pair which has the highest score in the book data structure is “James”, so that a speech recognition result, “James office”, is outputted in the speech recognizer, finally. If “silence” is recognized in the expansion vocabulary tree and the token information is “t”, the final speech recognition result is “James”.

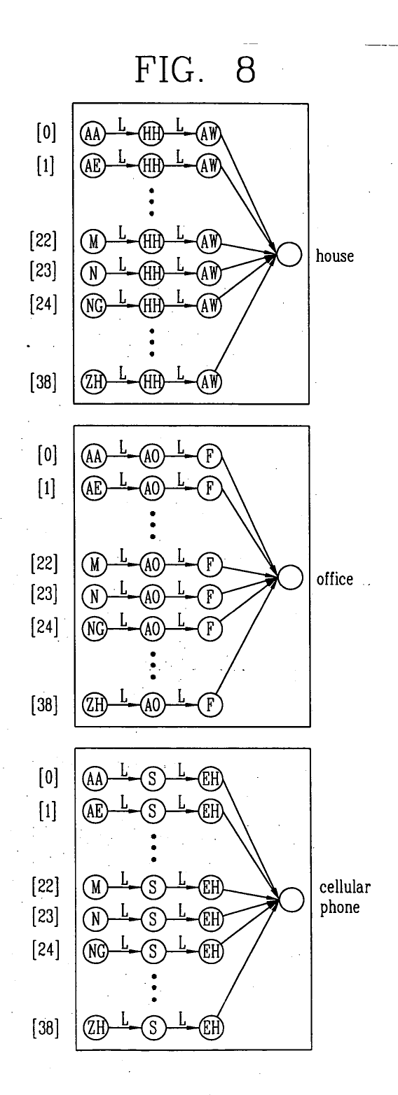

Hereinafter, a link sound connecting tree in accordance with the present invention will be described in detail with reference to FIGS. 7 and 8.

FIG. 7 is a table showing a CMU phoneset which contains 39 phones coming in the last position when an English word is changed into a phoneme sequence. Namely, when two words are uttered in a sequential order, link sound phenomenon (liaison phenomenon) occurs. Therefore, provision against occurrence of a link sound is required when constructing a lexical tree for speech recognition. In order to improve the speech recognition rate by recognizing the link sound between one word and another word, as shown in FIG. 8, a link sound connecting tree is preferably connected between the name tree and the expansion vocabulary tree.

As shown in FIG. 8, the link sound connecting tree is typically classified into three (house, office and cellular phone). For example, the link sound connecting tree is used to increase the recognition rate by dealing with the link sound phenomenon (liaison phenomenon) when uttering a name and an expansion word like “David office” sequentially and successively. There are 39 start nodes in the link sound connecting tree, and they are connected to each other by sibling links. “ER-HH-AW” is used to deal with the link sound phenomenon (liaison phenomenon) occurring when every word which contains “ER” as the last phone in a phoneme sequence of every word recognized in the name tree is connected to “house”. For example, the link sound connecting tree is used to recognize a link word such as “Baker house”. An experiment is carried out under implementation of the speech recognizer in order to compare the speech recognizer performance for which the link sound connecting tree is used with the speech recognizer performance for which the link sound connecting tree is not used. The experiment proves that the speech recognizer to which the link sound connecting tree is not applied shows much more excellent performance than the speech recognizer to which the link sound connecting tree is not applied.

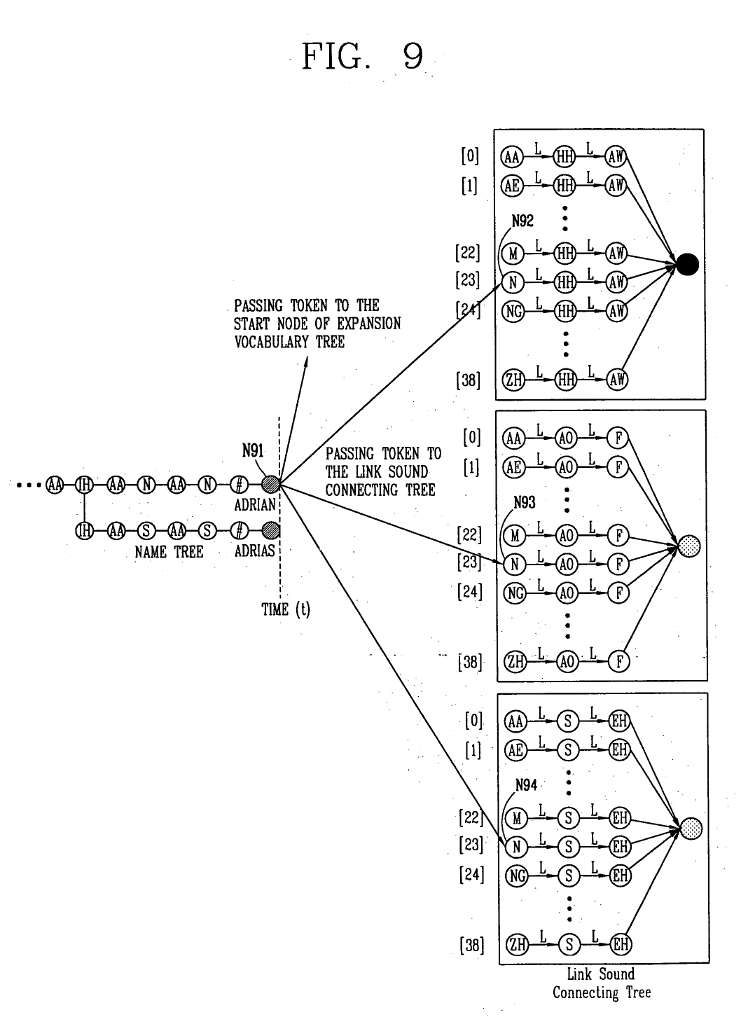

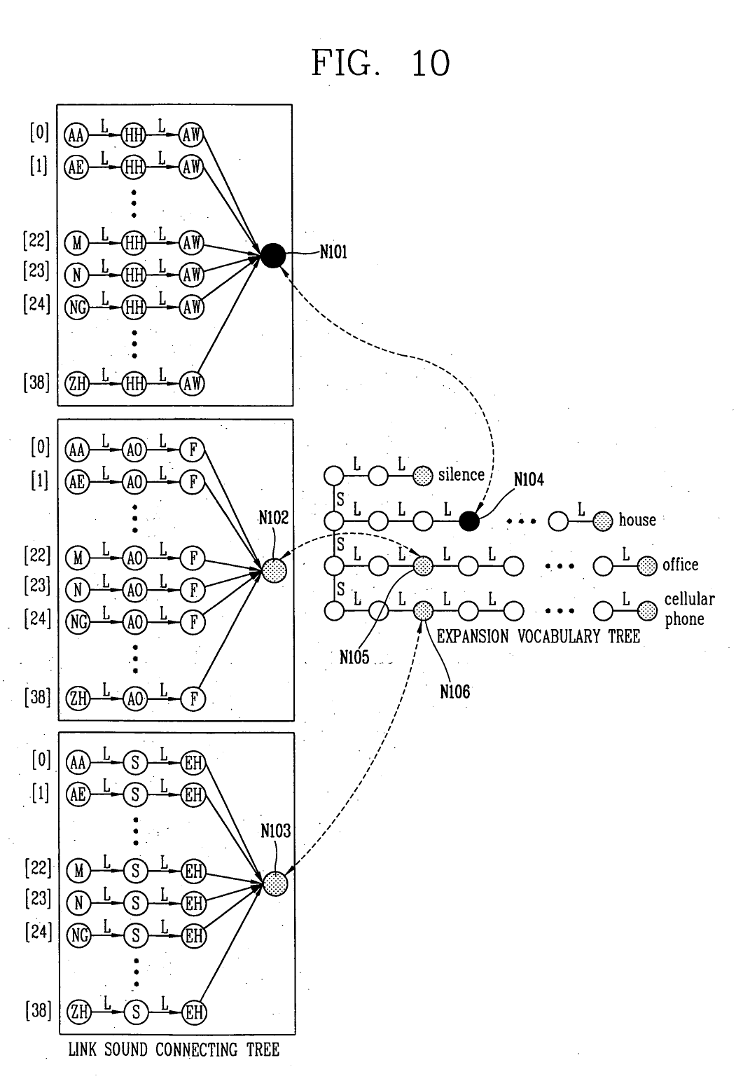

Hereinafter, a link state between the name tree and the link sound connecting tree in accordance with the present invention will be described in detail with reference to FIG. 9.

FIG. 9 is a view showing a link state between the name tree and the link sound connecting tree in accordance with the present invention.

As shown in FIG. 9, when there is an activated terminal node (N91) of the name tree in an arbitrary point of time (t), tokens are passed to start nodes of the expansion vocabulary tree first. Here, when the link sound phenomenon (liaison phenomenon) does not occur, by passing the token to the start node of the expansion vocabulary tree, the name tree is directly connected to the expansion vocabulary without passing the link sound connecting tree, preferably. At the same time, the tokens are passed to the link sound connecting tree. For example, since “N” is the last phone in the phoneme sequence of the recognized word “Adrian”, token information (time information) is passed to the 23rd nodes (N92, N93 and N94) of “house/office/cellular phone”. In addition, time information as token information is also passed to the link sound connecting tree, and information on all terminal nodes activated at the present time is recorded in the book data structure.

Hereinafter, a link state between the link sound connecting tree and the expansion vocabulary tree in accordance with the present invention will be described with reference to FIG. 10.

FIG. 10 is a view showing a link state between the link sound connecting tree and the expansion vocabulary tree in accordance with the present invention.

As shown in FIG. 10, the last nodes (N101, N102 and N103) of the link sound connecting tree (for example, link sound connecting trees for house, office and cellular phone) become nodes (N104, N105 and N106) of the expansion vocabulary tree, respectively. Namely, when the nodes (N104, N105 and N106) which come from the expansion vocabulary tree and the nodes (N101, N102 and N103) which come from the link sound connecting tree collide with each other, if tokens simultaneously come from both sides of channels in the arbitrary point of time (t) during a search process, a token having the highest HMM score is preferably selected from the tokens which have come in. Namely, at the arbitrary point of time (t), when the tokens which have been passed from the name tree to the expansion vocabulary tree and reached as far as N104, N105 and N106, respectively, and the tokens which have been passed to the link sound connecting tree and reached as far as N101, N102 and N103, respectively, collide with each other, the token having a higher score than the other is selected. For example, if N101 and N104 are identical to each other and therefore two tokens are simultaneously passed, the token having a higher score than the other is preferably selected.

As so far described, in the present invention, even though a name included in an address book in a communication device such as a cellular phone and an expansion word such as “house/office/cellular phone” are sequentially and successively uttered, the sequentially and successively uttered speech can be recognized at the high recognition rate. For example, by organically connecting the name tree, the expansion vocabulary tree and the link sound connecting tree to each other, a telephone number, which the user wants, can be rapidly, easily and precisely searched for.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A method for constructing a lexical tree for speech recognition, comprising:
constructing a lexical tree comprising a name tree composed of names included in an address book in a communication device and an expansion vocabulary tree composed of words which follow the names, respectively.

2. The method of claim 1, wherein the lexical tree further comprises a link sound connecting tree for recognizing a link sound between the name tree and the expansion vocabulary tree.

3. The method of claim 2, wherein the link sound connecting tree is positioned between the name tree and the expansion vocabulary tree.

4. The method of claim 1, wherein each word following each name is one of a house, an office and a cellular phone.

5. The method of claim 1, wherein the expansion vocabulary tree comprises a single silence node.

6. The method of claim 1, comprising:
storing pairs of name words of each of the terminal nodes activated at an arbitrary point of time and HMM (Hidden Markov Model) scores in a book in order to connect the name tree and the expansion vocabulary tree.

7. The method of claim 1, comprising:
searching for a word preceding the expansion vocabulary tree in a book data structure, when a search is completed to a terminal node of the expansion vocabulary tree after the current time information is passed to the expansion vocabulary tree, when a token is passed from the name tree to the expansion vocabulary tree, based on the passed time information, wherein the current time information indicates a time taken to determine similarities between the users' speech and the lexical tree.

8. The method of claim 1, wherein the lexical tree is applied to a speech recognizer of the cellular phone.

9. A method of constructing a lexical tree for speech recognition, comprising:
constructing a lexical tree including: a name tree composed of names recorded in an address book in a cellular phone; an expansion vocabulary tree composed of words following the names; and a link sound connecting tree connected between the name tree and the expansion vocabulary tree in order to recognize a link sound between the name tree and the expansion vocabulary tree.

10. The method of claim 9, wherein the word following the name is one of a house, an office and a cellular phone.

11. The method of claim 9, wherein the expansion vocabulary tree further comprises a single silence node, which is connected to a first node of the expansion vocabulary tree.

12. The method of claim 9, comprising:
storing pairs of name words of each of the terminal nodes activated at an arbitrary point of time and HMM (Hidden Markov Model) scores in a book in order to connect the name tree and the expansion vocabulary tree.

13. The method of claim 9, comprising:
searching for a word preceding the expansion vocabulary tree in a book data structure, when a search is completed to a terminal node of the expansion vocabulary tree after the current time information is passed to the expansion vocabulary tree, when a token is passed from the name tree to the expansion vocabulary tree, based on the passed time information, wherein the current time information indicates a time taken to determine similarities between the users' speech and the lexical tree.

14. The method of claim 9, wherein the link sound connecting tree is connected between the name tree and the expansion vocabulary tree in order to recognize a link sound between the name tree and the expansion vocabulary tree.

15. The method of claim 9, wherein the lexical tree is applied to a speech recognizer of the cellular phone.

16. A method for generating a lexical tree, comprising:
generating a name tree composed of names recorded in an address book in a cellular phone;
generating an expansion vocabulary tree composed of words following the names, respectively; and
generating a link sound connecting tree connected between the name tree and the expansion vocabulary tree in order to recognize a link sound occurring between the name tree and the expansion vocabulary tree.

17. A method for recognizing speech through a lexical tree applied to a speech recognizer in a communication device, comprising:
constructing a lexical tree comprising a name tree composed of names recorded in an address book in a communication device, an expansion vocabulary tree composed of words following the names, respectively, and a link sound connecting tree connected between the name tree and the expansion vocabulary tree in order to recognize a link sound between the name tree and the expansion vocabulary tree; and
recognizing speech though the constructed lexical tree.

18. The method of claim 17, wherein the lexical tree further comprises a single silence node which is connected between the name tree and the expansion vocabulary tree.
